(19) United States
(12) Patent Application Publication
(10) Pub. No.: US 2017/0356692 A1
(43) Pub. Date: Dec. 14, 2017

(54) Finned Heat Exchanger

(71) Applicant: Savannah River Nuclear Solutions, LLC, Aiken, SC (US)

(72) Inventors: Jacob L. Schaufler, North Augusta, SC (US); Paul S. Korinko, Aiken, SC (US)

(21) Appl. No.: 15/176,881

(22) Filed: Jun. 8, 2016

(51) Int. Cl. F28D 7/10; F28F 21/08; F28F 21/06; F28F 1/40; B33Y 10/00; B33Y 80/00

(52) U.S. Cl. CPC F28D 7/103; F28F 21/062; F28F 1/40; F28F 21/081; B33Y 80/00; B33Y 10/00

(57) ABSTRACT

The present invention is directed to a finned heat exchanger comprising an inner annulus, an outer annulus, a plurality of fins, and an outer chamber. The plurality of fins extends radially outward from the outer surface of the inner annulus toward the inner surface of the outer annulus. The outer chamber is located between the inner annulus and the outer annulus. The plurality of fins is located within the outer chamber. A method of heating or cooling a fluid using the finned heat exchanger and a method of forming the finned heat exchanger are also disclosed.

This invention was made with Government support under Contract No. DE-AC09-08SR22470, awarded by the U.S. Department of Energy. The Government has certain rights in the invention.

### BACKGROUND OF THE INVENTION

Heat exchangers are employed in a variety of applications for transferring heat, such as from one fluid to another or from a device such as a heating element to a fluid. These heat exchangers can be manufactured having various configurations including, but not limited to, tube in tube (or pipe in pipe) heat exchangers, finned heat exchangers, etc. In particular, regarding the latter, the finned heat exchangers typically employ fins which extend radially toward the central axis from an inner surface of a tube or pipe. In addition, some of these finned heat exchangers consist of a single tube or pipe containing fins which extend radially outward from an outer surface of the tube or pipe and into the open environment. While these heat exchangers may have their own benefits, they certainly leave a lot to be desired. For instance, these heat exchangers may not provide the desired heat exchange capacity and heat transfer rate and thus may not be particularly efficient.

As a result, there is a need to provide an improved heat exchanger that is capable of providing an improved heat exchange capacity and heat transfer rate.

### SUMMARY OF THE INVENTION

Aspects and advantages of the invention will be set forth in part in the following description, or may be apparent from the description, or may be learned through practice of the invention.

In accordance with one embodiment of the present invention, a finned heat exchanger is disclosed. The finned heat exchanger comprises an inner annulus, an outer annulus, a plurality of fins, and an outer chamber. The inner annulus defines an inner chamber and the inner annulus has an inner surface and an outer surface. The outer annulus has an inner diameter that is larger than an outer diameter of the inner annulus and the outer annulus has an inner surface and an outer surface. The plurality of fins extends radially outward from the outer surface of the inner annulus toward the inner surface of the outer annulus. The outer chamber is located between the inner annulus and the outer annulus. The plurality of fins is located within the outer chamber.

In accordance with another embodiment of the present invention, a method of heating or cooling a fluid is disclosed. The method comprises a step of transferring a first fluid through the inner chamber and a second fluid through the outer chamber of the finned heat exchanger.

In accordance with another embodiment of the present invention, a method of forming a finned heat exchanger is disclosed. The method comprises (a) using a computer-based system to operate upon data that corresponds to a geometric configuration of the finned heat exchanger and configuring a forming device to deposit a material and receive instructions related to the data such that upon receipt of the instructions, the forming device builds up the finned heat exchanger with the material.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 provides a cross-section of the heat exchanger as disclosed herein; and

FIG. 2 provides an enlarged view of a fin of the heat exchanger disclosed herein.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

Generally speaking, the present invention is directed to a heat exchanger. In particular, the present invention is directed to a finned heat exchanger comprising a plurality of fins as defined and illustrated herein.

The present inventors have discovered that a finned heat exchanger as disclosed herein is capable of providing an improved heat exchange capacity and heat transfer rate in comparison to many conventional heat exchangers, such as some conventional finned heat exchangers and/or tube in tube (or pipe in pipe) heat exchangers. To that extent, the finned heat exchanger as disclosed herein is capable of providing a more efficient means of transferring heat between fluids, such as between liquids, gases, or a combination thereof and/or heat between a device or element and a fluid.

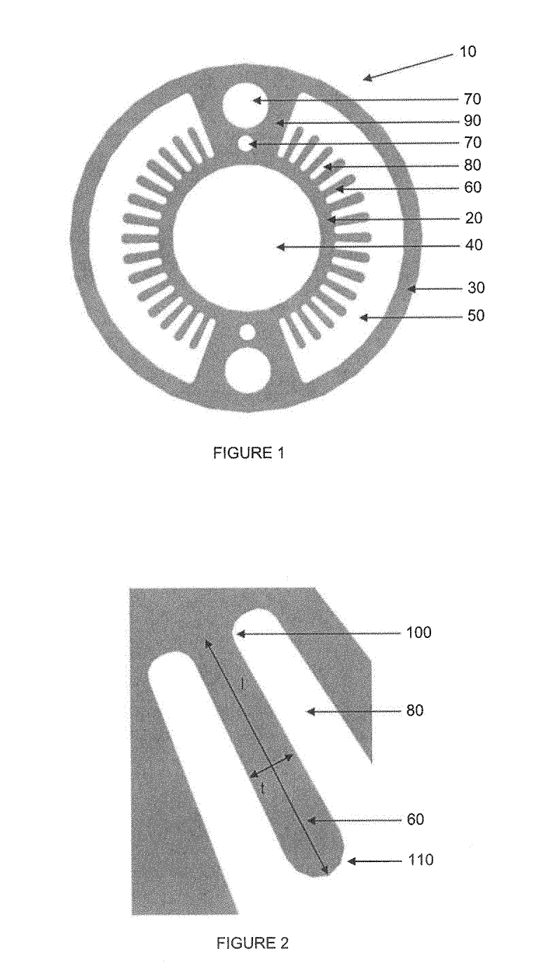

FIG. 1 illustrates a cross section of the finned heat exchanger 10 disclosed herein. In particular, the finned heat exchanger 10 comprises an inner annulus 20 and an outer annulus 30. The inner annulus 20 has an inner surface proximal to the center of the finned heat exchanger. The inner annulus 20 also has an opposing outer surface facing the inner surface of the outer annulus 30. The outer annulus 30 has an inner surface facing the outer surface of the inner annulus 20. The outer annulus 30 also has an opposing outer surface facing away from the center of the finned heat exchanger.

The inner annulus 20 is located closer to the center of the finned heat exchanger 10. In this regard, the outer annulus 30 has an inner diameter that is larger than the outer diameter of the inner annulus 20. For instance, the outer diameter of the inner annulus 20 is determined from the position at which the channels 80 between the fins 60 begin. In one embodiment, the inner annulus 20 and the outer annulus 30 are positioned so that they are concentric.

The inner annulus 20 defines an inner or central chamber 40. The chamber 40 is employed for transferring a first working fluid which can be heated and/or cooled while traversing through the finned heat exchanger. In this regard, a first fluid may pass through the chamber 40 defined by the inner annulus 20. The chamber 40 may have a circular configuration or shape.

The space between the outer surface of the inner annulus 20 and the inner surface of the outer annulus 30 defines an outer chamber 50. The chamber 50 is employed for transferring a second working fluid which can be heated and/or cooled while traversing through the finned heat exchanger. In this regard, a second fluid may pass through the chamber 50 defined by the space between the outer surface of the inner annulus 20 and the inner surface of the outer annulus 30.

As illustrated in FIG. 1, the finned heat exchanger includes a plurality of fins 60. Without intending to be limited by theory, it is believed that the surface area of the fins allows for a desired heat exchange rate and capacity.

In general, the fins 60 extend radially outward from the outer surface of the inner annulus 20 and toward the inner surface of the outer annulus 30. However, the fins 60 do not extend all the way to the outer annulus 30 such that the fins 60 do not directly contact the inner surface of the outer annulus 30. For instance, the fins 60 may extend 40% or more, such as 50% or more, such as 55% or more, such as 60% or more, such as 65% or more, such as 70% or more, such as 75% or more, such as 80% or more, such as 85% or more, such as 90% or more and less than 100%, such as 95% or less, such as 90% or less, such as 85% or less, such as 80% or less the distance in the radial direction between the outer surface of the inner annulus 20 and the inner surface of the outer annulus 30.

In one embodiment, the fins 60 may extend radially from the inner surface of the inner annulus 20 toward the center of the finned heat exchanger 10. In one embodiment, the fins 60 may extend radially from the outer surface of the inner annulus 20 as indicated above and a second set of fins may extend radially from the inner surface of the inner annulus 20 toward the center of the finned heat exchanger 10.

In general, allowing the fins to extend in the manner as indicated above can provide certain advantages. For instance, without intending to be limited by theory, a heat exchanger may be less likely to fail during low cycle fatigue, unlike those in which the fins extend and contact both the inner annulus and the outer annulus (i.e., 100% extension). However, it should be understood that various other benefits can be recognized by configuring the fins in a manner as disclosed herein.

The configuration of the fins 60 can be better demonstrated by reference to FIG. 2. The fins 60 have a first end 100 located proximally to the inner annulus 20 and a second and opposite end 110 located proximally to the outer annulus 30. The first end 100 may be considered the location at which the fin extends from the outer surface of the inner annulus 20. The fins 60 have a length (l) which is the length from the outer surface of the inner annulus 20 to the second end 110 of the fins 60. In addition, the fins also have a thickness (t) which may vary along the length of the fins 60.

In one embodiment, along the length (l) of the fins 60, the thickness (t) of the fin increases from the point of formation of the arc of the channel 80 up until the formation of the arc at the second end 110. The channel 80 forms an arc adjacent the inner annulus 20 and the fins form an arc at the second end 110 and proximally to the outer annulus 30. For instance, at some length along the fins, the arc of the channels begins to form and the arc of the fins begins to form. In one embodiment, the thickness of the fins at the point of formation of the arc of the channels is less than the thickness of the fins at the point of formation of the arc of the fins.

For instance, across the entire length (l) of the fins 60 when going from end 100 toward end 110, the thickness (t) of the fins 60 increases across 50% or more, such as 60% or more, such as 70% or more, such as 80% or more of the length (l) of the fins 60.

In one embodiment, when going from the inner end 100 toward the outer end 110, the thickness (t) of the fins 60 at ½ of the length of the fins 60 is less than the thickness (t) at ¾ of the length of the fins 60 and greater than the thickness (t) at ¼ of the length (l) of the fins 60.

In one embodiment, when going from the inner end 100 toward the outer end 110, the average thickness of the first quarter of the length (l) of the fins 60 is less than the average thickness of the second quarter, third quarter, and the fourth quarter of the length (l) of the fins 60. In this regard, the average thickness of the fourth quarter of the length (l) of the fins 60 is greater than the average thickness of the first quarter, second quarter, and third quarter of the length (l) of the fins 60.

Similarly, in one embodiment, when going from the inner end 100 toward the outer end 110, the average thickness of the first third of the length (l) of the fins 60 is less than the average thickness of the second third and final third of the length (l) of the fins 60. In this regard, the average thickness of the final third of the length (l) of the fins 60 is greater than the average thickness of the first third and the second third of the length (l) of the fins 60.

In one embodiment, the thickness (t) of the fins 60 located proximally to the outer annulus 30 is greater than the thickness (t) of the fins 60 at an area located proximally to the inner annulus 20. In one embodiment, the thickness (t) of the fins 60 increases gradually over the length (l) of the fins 60. In another embodiment, the thickness (t) of the fins 60 does not increase gradually over the length (l) of the fins 60.

In one embodiment, the fins 60 have a symmetrical cross-section, such as along the radial direction. In one embodiment, the second ends 110 located proximal to the outer annulus 30 may have an arc shaped configuration. However, without intending to be limited, the second ends 100 may have any other configurations employed in the art, such as a beveled edge configuration, a straight edge configuration, etc.

In addition, in one embodiment, the fins 60 do not have a convex configuration along the length of the fins 60. In one embodiment, the fins 60 do not have a concave configuration along the length of the fins 60. In one embodiment, the fins 60 do not have a convex configuration or a concave configuration along the length of the fins 60.

In one embodiment, the fins 60 are arranged so that their radial lines pass orthogonally through the central axis of the finned heat exchanger. In this regard, the fins 60 are oriented so that they are parallel to the axial direction of the finned heat exchanger. That is the fins 60 extend along the axial direction of the finned heat exchanger and outwardly in the radial direction of the finned heat exchanger. For instance, in on embodiment, the fins 60 do not form a helical path about the central axis of the finned heat exchanger. In this regard, the fins 60 have a 0 degrees twist about the longitudinal or central axis of the finned heat exchanger. Within a chamber, the fins 60 may be uniformly spaced apart from each other.

The finned heat exchanger may include 5 or more, such as 10 or more, such as 15 or more, such as 20 or more fins in at least one outer chamber. Overall, the finned heat exchanger may include 10 or more, such as 20 or more, such as 30 or more, such as 40 or more fins. However, it should be understood that the heat exchanger may include any number of fins based on the size of the finned heat exchanger and the desired heat exchange capacity and heat transfer rate.

In one embodiment, the finned heat exchanger may contain at least two outer chambers 50 containing fins 60. For instance, the space between the inner annulus 10 and the outer annulus 30 may be partitioned to create at least 2, such as at least 3, such as at least 4, such as at least 5 chambers. The fins 60 may be present in at least one outer chamber. In one embodiment, the fins 60 may be present in at least two outer chambers, such as at least three outer chambers, such as at least four outer chambers. However, it should be understood that not all of the outer chambers need to contain fins 60. For instance, it should be understood that at least one outer chamber, such as at least two outer chambers, such as at least three outer chambers, such as at least four outer chambers may not contain any fins 60.

In addition, as illustrated in FIG. 1, a connecting body 90 may be utilized to connect or bridge the inner annulus 20 to the outer annulus 30. In particular, the connecting body 90 may be utilized to connect or bridge the outer surface of the inner annulus 20 to the inner surface of the outer annulus 30. The connecting body 90 may define a body chamber 70. In this regard, a body chamber 70 is a chamber that is surrounded by the connecting body 90. The connecting body 90 may include at least one body chamber 70, such as at least two body chambers 70, such as at least three body chambers 70. When employing at least two body chambers 70, one body chamber may have a diameter that is smaller than the second body chamber.

The body chambers may be utilized to provide various benefits and/or may be equipped to contain certain elements or devices. For instance, at least one body chamber may be utilized to provide a thermocouple probe for measuring the temperature. In particular, when body chambers having different sizes (e.g., diameters) are employed, the smaller chamber may be equipped with a thermocouple probe.

At least one body chamber may be utilized to provide a heating element, such as an electrical heating element. The fluid traversing through the heat exchanger may be heated via the heat element employed in the body chamber. In particular, when body chambers having different sizes (e.g., diameters) are employed, the larger chamber may be equipped with a heating element.

In addition, the finned heat exchanger may also be configured to include various other components. For instance, the finned heat exchanger may be configured to include a flowmeter to gauge the flow of any of the fluids that pass through the chamber(s).

The finned heat exchanger may include at least one connecting body 90, such as at least two connecting bodies 90, such as at least three connecting bodies 90, such as at least four connecting bodies 90. It should be understood that each or all of the additional connecting bodies may also contain respective body chambers 70 as described herein. For instance, each connecting body may contain more than one body chamber 70, such as at least two body chambers 70 as described herein.

It should be understood that the finned heat exchanger disclosed herein may be manufactured using any method known in the art.

In one embodiment, the inner annulus 20, the outer annulus 30, the fins 60, and the connecting body 90 are integrally formed. That is, they consist of a single unitary body. For instance, the components are formed from one process and are integrally connected. That is, in one embodiment, the inner annulus 20, the outer annulus 30, the fins 60, and the connecting body 90 are not manufactured separately and thereafter combined or connected. In this regard, the finned heat exchanger may be comprised of a single body containing the inner annulus 20, the outer annulus 30, the fins 60, and the connecting body 90.

In one embodiment, the finned heat exchanger may be formed via an extrusion process. Such extrusion process may employ a die to allow the components of the finned heat exchanger to be integrally formed and/or connected.

In another embodiment, the finned heat exchanger may be formed via a 3-D printing or additive manufacturing process using techniques generally known in the art. When employing additive manufacturing, the finned heat exchanger is built up layer upon layer as part of a printing process. In particular, the printing device reads data pertaining to a model and then lays down successive layers of a material such that it builds up the object from a series of cross sections. The materials are joined or fused so as to create the final object. The various techniques for employing additive manufacturing are disclosed in WO 2013/163398 to Schevets and WO 2015/022527 to Potter, both of which are incorporated herein by reference in their entirety.

In particular, without intending to be limited by theory, additive manufacturing can be conducted by using a computer-based system to operate upon data that corresponds to a geometric configuration of the finned heat exchanger and configuring a forming device to deposit a material and receive instructions related to the data such that upon receipt of the instructions, the forming device builds up the finned heat exchanger with the material. The forming device may be a 3-D printer such that the 3-D printer builds up the finned heat exchanger in a layer-by-layer deposition of the material.

The material used to form the 3-D printed finned heat exchanger may be any material generally employed in the art. For instance, the material used to form the 3-D printed finned heat exchanger may be a metal powder or a polymer. For instance, the metal powder may be any metal employed in the art for additive manufacturing, such as steel, stainless steel, an iron-based alloy, a cobalt-chrome alloy, a nickel-based alloy, and/or a titanium alloy. The polymer may be any polymer employed in the art for additive manufacturing, such as acrylonitrile butadiene styrene, polycarbonate, and/or nylon.

Without intending to be limited, the finned heat exchanger disclosed herein may be employed in various industries and for various applications. For instance, the finned heat exchanger may be employed in any gas process plant, in particular one that may require a more rapid and efficient heat transfer. The finned heat exchanger may also be employed throughout the manufacturing and power industries. In addition, the finned heat exchanger may also be implemented into a thermal cycling absorption process (TCAP), such as in a chromatographic process for hydrogen isotope separation.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

1. A finned heat exchanger comprising:
an inner annulus defining an inner chamber, the inner annulus having an inner surface and an outer surface;
an outer annulus having an inner diameter larger than an outer diameter of the inner annulus, the outer annulus having an inner surface and an outer surface;
a plurality of fins extending radially outward from the outer surface of the inner annulus toward the inner surface of the outer annulus; and
an outer chamber between the inner annulus and the outer annulus, wherein the plurality of fins are located within the outer chamber.

2. The finned heat exchanger according to claim 1, wherein the fins do not contact the inner surface of the outer annulus.

3. The finned heat exchanger according to claim 1, wherein the fins extend 50% or more to less than 100% of the distance between the outer surface of the inner annulus and the inner surface of the outer annulus.

4. The finned heat exchanger according to claim 1, wherein the fins extend 60% or more to less than 90% of the distance between the outer surface of the inner annulus and the inner surface of the outer annulus.

5. The finned heat exchanger according to claim 1, wherein the finned heat exchanger further comprises a plurality of fins extending radially inward from the inner surface of the inner annulus.

6. The finned heat exchanger according to claim 1, wherein a plurality of channels are formed between the plurality of fins, the channels forming an arc adjacent the inner annulus and the fins forming an arc proximally to the outer annulus, wherein the thickness of the fins at a point of formation of the arc of the channels is less than the thickness of the fins at a point of formation of the arc of the fins.

7. The finned heat exchanger according to claim 1, wherein the fins have a first end located proximally to the inner annulus and a second and opposite end located proximally to the outer annulus and wherein the fins have a length in a direction from the first end to the second end, wherein the thickness of the fins at ½ of the length of the fins is less than the thickness of the fins at ¾ of the length of the fins and greater than ¼ of the length of the fins.

8. The finned heat exchanger according to claim 1, wherein the fins have a first end located proximally to the inner annulus and a second and opposite end located proximally to the outer annulus, wherein the second and opposite ends have an arc shaped configuration.

9. The finned heat exchanger according to claim 1, wherein the fins have a symmetrical configuration in the radial direction.

10. The finned heat exchanger according to claim 1, wherein the fins have radial lines that pass orthogonally through a central axis of the finned heat exchanger.

11. The finned heat exchanger according to claim 1, wherein the fins are parallel to the axial direction of the finned heat exchanger.

12. The finned heat exchanger according to claim 1, wherein the fins have a 0 degrees twist about the central axis of the finned heat exchanger.

13. The finned heat exchanger according to claim 1, wherein the finned heat exchanger comprises 20 or more fins.

14. The finned heat exchanger according to claim 1, further comprising a second outer chamber, wherein the first outer chamber and the second outer chamber each comprise 10 or more fins.

15. The finned heat exchanger according to claim 1, further comprising a connecting body for connecting the inner annulus to the outer annulus.

16. The finned heat exchanger according to claim 15, wherein the connecting body defines at least one body chamber.

17. The finned heat exchanger according to claim 15, wherein the connecting body defines a first body chamber and a second body chamber, the first body chamber having a diameter that is smaller than a diameter of the second body chamber.

18. The finned heat exchanger according to claim 1, wherein the fins are integrally formed with the inner annulus.

19. The finned heat exchanger according to claim 15, wherein the inner annulus, the outer annulus, the fins, and the connecting body are integrally formed.

20. The finned heat exchanger according to claim 1, further comprising a thermocouple.

21. The finned heat exchanger according to claim 1, further comprising a heating element.

22. A method of heating or cooling a fluid, the method comprising:
transferring a first fluid through the inner chamber and a second fluid through the outer chamber of the finned heat exchanger of claim 1.

23. A method of forming a finned heat exchanger, the method comprising:
using a computer-based system to operate upon data that corresponds to a geometric configuration of the finned heat exchanger of claim 1; and
configuring a forming device to deposit a material and receive instructions related to the data such that upon receipt of the instructions, the forming device builds up the finned heat exchanger with the material.

24. The method according to claim 23, wherein the forming device is a 3-D printer.

25. The method according to claim 23, wherein the material comprises a metal.

26. The method according to claim 23, wherein the material comprises a polymer.
